(19) United States
(12) Patent Application Publication
(10) Pub. No.: US 2022/0396047 A1
(43) Pub. Date: Dec. 15, 2022

(54) TABLET PRESS MACHINE AND COMPRESSION METHOD

(71) Applicant: I.M.A. INDUSTRIA MACCHINE AUTOMATICHE S.P.A., Ozzano Dell'emilia (BO) (IT)

(72) Inventors: Salvatore Fabrizio CONSOLI, Ozzano Dell'emilia (BO) (IT); Marco CORONA, Ozzano Dell'emilia (BO) (IT)

(21) Appl. No.: 17/771,138

(22) PCT Filed: Oct. 20, 2020
(86) PCT No.: PCT/IB2020/059839

§ 371 Date: Apr. 22, 2022

(30) Foreign Application Priority Data
Oct. 23, 2019 (IT) 102019000019649

(51) Int. Cl. B30B 11/08; B30B 11/02; B30B 11/00

(52) U.S. Cl. CPC B30B 11/08; B30B 11/027; B30B 11/005

(57) ABSTRACT

A rotary tablet press machine comprises a rotating compression turret which includes a die table, provided along a circumferential portion thereof with a plurality of dies, a plurality of first punches and second punches associated with respective dies; a dosing station for dosing high-porosity powdered product in the dies; a compression station provided with a first and a second compression roller adapted to linearly move respectively the first punches and the second punches within the respective dies in order to compress said product and producing tablets; and a compacting station arranged between the dosing station and the compression station and provided with at least one compacting cam adapted to push the first punches and/or the second punches within the respective dies in order to compact the dosed product and allow air in said product to exit.

The present invention relates to tablet press machines for producing tablets, lozenges, pills, for example for pharmaceutical, cosmetic, food, chemical use, by compressing a powdered or granular product. In particular, the invention concerns a rotary tablet press machine and a method for producing tablets in a rotary tablet press machine.

The known rotary tablet press machines typically comprise a compression turret, rotating about a vertical axis and formed by a die table or plate provided with a plurality of dies, i.e. through cavities, angularly distributed equidistant along a circumferential portion of the table and arranged to receive a powdered or granular product dispensed in a apposite dosing station. The turret further comprises a plurality of upper punches and lower punches associated with the respective dies and moved linearly and vertically by cams and compression rollers during the turret rotation.

The lower punches form with the dies seats or housings adapted to receive the product in a dosing station in which the product is inserted in the dies that are closed below by the lower punches. The upper punches and lower punches then compress the inserted product so as to produce the tablets, which are then extracted from the table dies by means of the lower punches that are raised up and afterwards conveyed in an exit chute.

The various manufacturing steps of a tablet are performed during in a single turn of the compression turret which rotates with continuous motion.

The compression of the product in the dies generally occurs in two steps. In a pre-compression station the product is compressed with a limited compression force in order to remove most of the air contained in the product. In a following main compression station the air-deprived product is compressed with high compression force so as to form a tablet. Each pre-compression/compression station comprises an upper compression roller and a lower compression roller, both rotating about horizontal axes and acting respectively on the upper punches and on the lower punches so as to linearly move the punches towards each other within the dies.

The position of the pair of compression rollers, i.e. the distance thereof, is adjustable according to the quantity of product dosed in the dies, the characteristics of the product and above all the amount of compression to be applied on the product in order to obtain tablets having the required dimensions, shape, hardness, porosity.

In order to ensure a high productivity of the tablet press machine and therefore a corresponding high rotation speed of the compression turret, the pre-compression and compression steps must have a very short duration, and this require a quick movement of the upper and lower punches within the dies to compress the product.

In the case of powdered products with high porosity or soft because they contain a significant percentage of air, the high speed with which the upper and lower punches are linearly moved does not allow, also in the pre-compression step, the complete exit from the dies of the air contained in the product. The remaining air does not allow a subsequent correct and homogeneous compression of the powder, since it interferes with the development of the cohesion forces between the solid particles of the powder necessary to form and keep the tablet stable.

To overcome this drawback, it is possible to decrease the movement speed of the punches so as to increase the duration of the pre-compression and compression steps and allow the air to completely exit from the product. Alternatively, it has been proposed to produce punches with larger heads in order to increase the compression time.

However, in both of the aforementioned cases there is a decrease in the productivity of the tablet press machine.

An object of the present invention is to improve the known tablet press machines, in particular rotary tablet press machines having a compression turret provided with dies and punches driven by compression rollers.

Another object is to provide a tablet press machine and a method which allow the optimal compression of soft and/or high-porosity powdered products so as to obtain regular and stable tablets without decreasing the operating speed of the tablet press machine and therefore the productivity thereof.

A further object is to obtain a tablet press machine and a method which allow the complete exit of the air contained in a soft and/or high-porosity powdered product during the tablet formation steps.

In a first aspect of the invention a rotary tablet press machine according to claim 1 is provided.

In a second aspect of the invention a method for producing tablets according to claim 9 is provided.

The invention can be better understood and implemented with reference to the attached drawings which illustrate an exemplary and non-limiting embodiment thereof, in which:

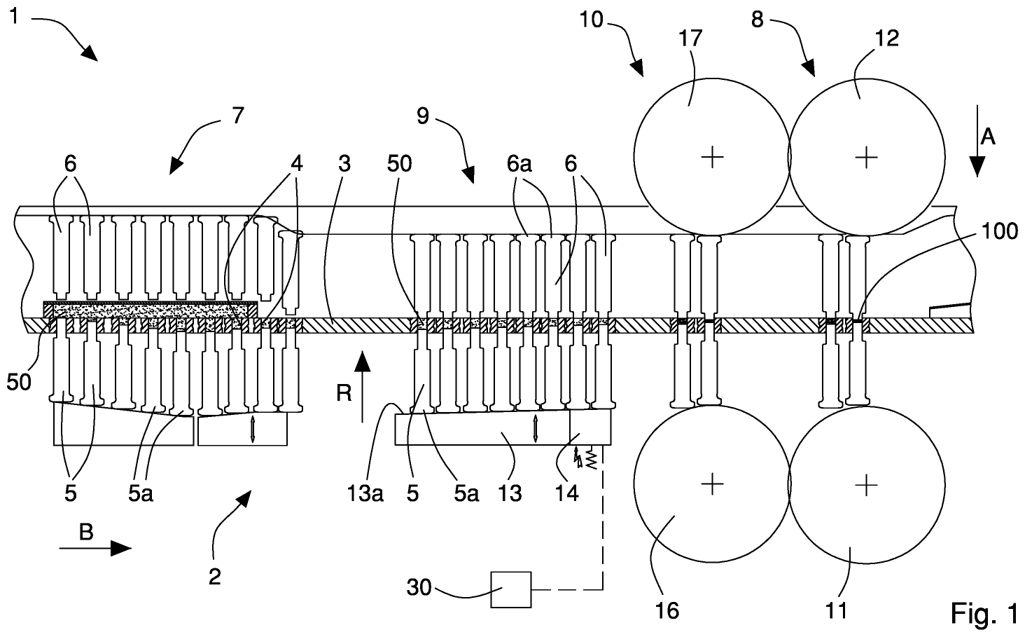

FIG. 1 is a schematic view of a rotary tablet press machine according to the invention;

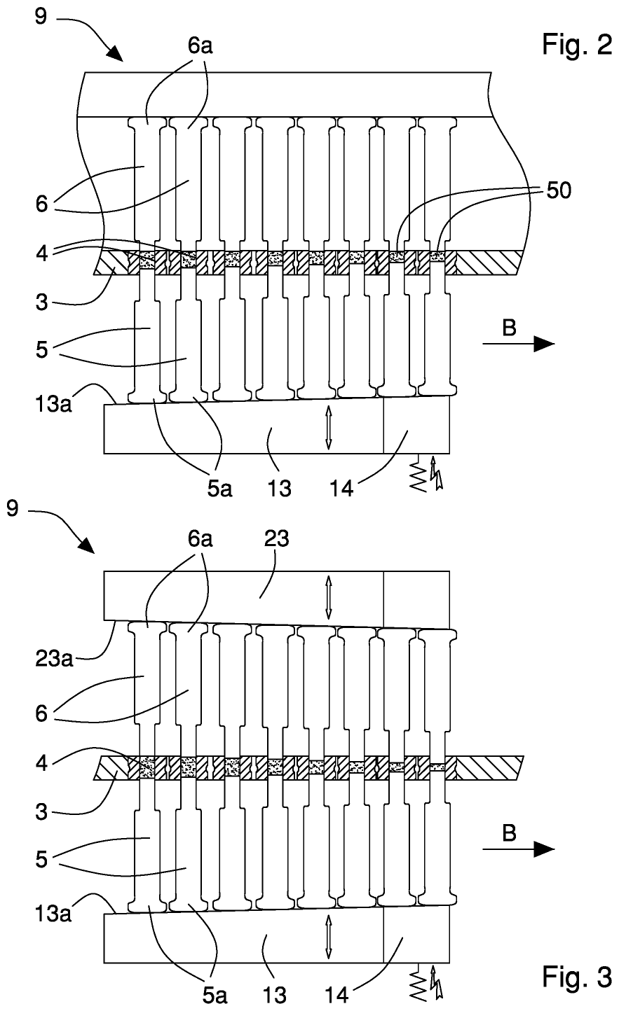

FIG. 2 is an enlarged and partial view of the tablet press machine of FIG. 1 in particular showing a compacting station of the product;

FIG. 3 is an enlarged and partial view of a variant of the tablet press machine of FIG. 1 in particular showing the compacting station of the product.

With reference to FIGS. 1 and 2, a rotary tablet press machine 1 according to the invention is showed, that is arranged to produce tablets, lozenges, pills by compressing a powdered or granular product 50 for pharmaceutical, cosmetic, food or chemical use and in particular a soft and/or high-porosity powdered product.

The tablet press machine 1 comprises a compression turret 2 which is rotating about a vertical rotation axis and which includes a die table 3, provided along a circumferential portion or edge thereof with a plurality of dies 4, a plurality of first punches 5 and a corresponding plurality of second punches 6 associated in pairs with respective dies 4 and movable to compress a product 50 introduced in the dies 4 so as to produce tablets, lozenges or pills.

The dies 4 are through cavities obtained in the die table 3 which form, in cooperation with the first and second punches 5, 6, the seats or housings in which a product 50 is dosed and subsequently compressed to form the tablets 100.

The tablet press machine 1 comprises a dosing station 7 arranged to deliver a fixed amount of product 50 to be compressed within the dies 4 and at least one compression station 8, or main compression station, provided with a first compression roller 11 and a second compression roller 12 adapted to respectively drive the first punches 5 and the second punches 6 along a compression direction A (FIG. 1) within the respective dies 4 in order to compress the product 50 delivered in the dies 4 themselves and obtain the tablets 100.

In the embodiment shown in FIGS. 1 and 2, the compression direction A is substantially vertical, i.e. parallel to the rotation axis of the turret 2, and the first punches 5 are the lower punches, while the second punches 6 are the upper punches. Likewise, the first compression roller 11 is the lower compression roller acting on the lower punches 5 and the second compression roller 12 is the upper compression roller acting on the upper punches 6.

The compression station 8 comprises actuating means of a known type, and therefore not illustrated and described in further detail, acting on the first compression roller 11 or on the second compression roller 12 with an settled, almost constant operating force so that the first compression roller 11 or the second compression roller applies on the first punches 5 or the second punches 6 respectively an settled, almost constant compression force.

The compression roller 11, 12 which is not driven by the actuating means is rotatably connected to a support frame of the tablet press machine 1.

Each punch of the plurality of first punches 5 and of the plurality of second punches 6 has a substantially cylindrical body provided with a respective abutment end 5a, 6a (or follower end) on which the first compression roller 11 and the second compression roller 12 act in contact, which are thus able to impart to the punch the thrust needed to compress the product 50 within the respective die 4.

The rotary tablet press machine 1 further comprises a compacting station 9 positioned between the dosing station 7 and the compression station 8 and provided with at least one compacting cam 13 cooperating with the first punches 5 or the second punches 6.

In the compacting station 9 the abutment ends 5a, 6a of the first punches 5 and/or the second punches 6 are configured to cooperate in contact with the compacting cam 13; the latter defines or has a sliding surface 13a (or driver profile) on which the abutment ends 5a, 6a slide in contact so as to push the first punches 5 and/or the second punches 6 within the respective dies 4, with a predefined compacting force, which is lower than the settled compression force imparted by the first compression roller 11 and the second compression roller 12 on the first punches 5 and/or the second punches 6, in order to compact the dosed product 50 and allow air in the product 50 to exit.

In the embodiment shown in FIGS. 1 and 2, the compacting cam 13 is arranged to move the first punches 5 (lower) along the compression direction A, while the second punches 6 (upper) remain fixed.

However, in an alternative embodiment of the tablet press machine 1 of the invention not shown in the figures, it is provided that the compacting cam 13 is arranged to move the second punches 6 (upper) along the compression direction A, while the first punches 5 (lower) are kept fixed.

The compacting cam 13 is configured to move the first punches 5 in the compacting station 9 for a compacting time Tc equal to 10-25 times a compression time Tp in which the first punches 5 and the second punches 6 are moved in the compression station 8 to compress the product 50. In this way, during the rotation of the compression turret 2 at a settled constant speed, the first punches 5 are moved by the compacting cam 13 within the dies 4 with a speed much lower than the speed with which they are moved by the first compression roller 11 in the compression station 8.

The lower speed of the first punches 5 allows to optimally compact the product 50 dosed within the dies 4 since it allows any air in the product to exit, typically if the product is a soft, high-porosity powdered product. During the compacting time Tc the air is in fact capable of exiting through suitable passages provided in the dies and/or punch and not to remain trapped in the product, compromising the subsequent compression operation.

The sliding surface 13a or driver profile of the compacting cam 13 has, for example, a rectilinear profile to give the first punches 5 a linear motion law.

The compacting cam 13 is also adjustable along an adjustment direction R, parallel to the rotation axis of the compression turret 2, to vary a stroke of the first punches 5 within the respective dies 4 i.e. to vary the degree of compacting of the product 50 according to chemical-physical features thereof (e.g. lower or higher porosity, solid particle size of the powder, cohesion force between the aforementioned particles, etc.).

The compacting station 9 preferably further comprises a load measuring element 14, for example a load cell associated with the compacting cam 13 and arranged to measure a compacting force applied by the first punches 5 on the product 50 contained within the respective dies 4.

The load cell 14 is connected to a control unit 30 of the tablet press machine 1 to send data relating to the values of the measured compacting force. The control unit 30 is configured to receive said data relating to the values of the measured compacting force so as to stop the operation of the tablet press machine 1 in case of anomalies and/or to adjust the position of the compacting cam 13 along the adjustment direction R to change the value of the compacting force.

In the embodiment shown in FIGS. 1 and 2, in addition to the compression station 8, the tablet press machine 1 comprises a pre-compression station 10 interposed between the compacting station 8 and the compression station 9 and provided with a first pre-compression roller 16 acting on the first punches 5 and a second pre-compression roller 17 acting on the second punches 6.

In the pre-compression station 10 the product 50 is compressed at a rapid speed with a limited compression force in order to remove any residual air remaining in the product 50 after the compacting performed in the previous compacting station 9, so that in the compression station 8 the product 50, deprived of air, can be compressed with high compression force and in a reduced compression time Tc and form tablets 100 having the required dimensional, shape, hardness, porosity characteristics.

In the normal operation of the tablet press machine 1 of the invention, the compacting station 9 positioned downstream of the dosing station 7, with reference to a rotation direction B of the compression turret 2, compacts the product 50 dosed within the dies 4, allowing the almost complete exit of any air in the product 50, through apposite passages provided in the dies and/or in the punch(es). In fact, the compacting cam 13 is configured to move the first punches 5 within the dies 4 with a much lower speed than the speed with which the first punches are moved by the first compression roller 11 in the compression station 8 since the compacting time Tc available to perform the operation is much longer than the compression time Tp during which the first punches 5 (and the second punches 6) are moved in the compression station 8.

The lower speed of the first punches 5 considerably facilitates the exit of air among the solid particles forming the powder, especially if the powder is soft and/or with high porosity.

In this manner, in the successive pre-compression 10 and compression 8 stations the product 50, almost free of air, can be optimally compressed so as to obtain tablets, pills, lozenges having settled dimensions, shape, compactness and porosity.

Thanks to the rotary tablet press machine 1 of the invention provided with a special compacting station 9 upstream of the compression station 8 (and any pre-compression station 10) with reference to the rotation direction B of the compression turret 2, it is therefore possible to optimally compress also soft and/or high-porosity powdered products, i.e. products that are difficult to compress, and obtain regular and stable tablets, without decreasing the operating speed of the tablet press machine 1 and therefore the productivity thereof. In fact, it is possible, before the compression step, to eliminate almost completely the air contained in the product in the compacting station 9.

With reference to FIG. 3, a variant of the tablet press machine 1 of the invention is shown that differs from the embodiment described above and illustrated in FIGS. 1 and 2 for the compacting station 9 which, in addition to the compacting cam 13 acting on the first punches 5 (lower), comprises a further compacting cam 23 arranged to move the second punches 6 (upper) within the respective dies 4.

In this variant of the tablet press machine 1 both punches 5, 6 are moved in the same die 4 to compact the product 50.

The further compacting cam 23 has a respective sliding surface 23a (or driver profile) adapted to abut a respective abutment end 6a of the second punches 6 and also having a rectilinear profile identical or different from the driver profile 13a of the compacting cam 13.

The method according to the invention for producing tablets in a rotary tablet press machine 1 that comprises a rotating compression turret 2, which includes a die table 3, provided along a circumferential portion thereof with a plurality of dies 4, a plurality of first punches 5 and a corresponding plurality of second punches 6 associated in pairs with the respective dies 4, with the first punches 5 and the second punches 6 having a substantially cylindrical body provided with an abutment end 5a, 6a on which respectively a first compression roller 11 and a second compression roller 12 of the tablet press machine act in contact, comprises the steps of:
dosing in the dies 4 a product 50, in particular a high-porosity powdered product;
compressing the product 50 dosed in the dies 4 by moving the first punches 5 and the second punches 6, imparting a settled thrust on the abutment ends 5a, 6a of the respective first punches 5 and second punches 6 by means of contact with the first compression roller 11 and the second compression roller 12 in order to compress the product 50 within the respective dies 4 so as to produce tablets 100; and
after said dosing and before said compressing, compacting the product 50 dosed in the dies 4 by applying on the abutment ends 5a, 6a of the first punches 5 and/or the second punches 6 a predefined compacting force carried out by sliding in contact the abutment ends 5a, 6a along at least one compacting cam 13, 23 so as to push the first punches 5 and/or the second punches 6 within the respective dies 4 and allow air in the product 50 to exit.

The method provides compacting the product 50 in the dies 4 in a compacting time Tc equal to 10-25 times a compression time Tp during which said compressing is performed.

The method further comprises measuring during the compacting step a compacting force applied by the first punches 5 and/or the second punches 6 on the product 50 within the dies 4.

The method further comprises adjusting the compacting force applied by the first punches 5 and/or the second punches 6 on the product within the dies 4 by adjusting the position of the compacting cam 13, 23, in particular along an adjustment direction R, parallel to the rotation axis of the compression turret 2.

The method comprises, after said compacting and before said compressing, pre-compressing the product 50 in the dies 4 by moving the first punches 5 and the second punches 6 within said dies 4.

1. A rotary tablet press machine comprising:
a rotating compression turret which includes a die table provided along a circumferential portion thereof with a plurality of dies, a plurality of first punches and a corresponding plurality of second punches associated in pairs with respective dies;
a dosing station for dosing a product in said dies;
a compression station provided with a first compression roller and a second compression roller adapted to linearly move respectively said first punches and said second punches within the respective dies in order to compress said product and producing tablets;
a compacting station arranged between said dosing station and said compression station and provided with at least one compacting cam cooperating with said first punches and/or said second punches;
wherein each punch of said plurality of first punches and second punches has a substantially cylindrical body with an abutment end on which said first compression roller and said second compression roller act in contact, imparting to the punch a thrust to compress said product within the respective dies;
wherein said compacting station said abutment ends of said first and/or second punches are configured to cooperate in contact with said at least one compacting cam which defines a sliding surface on which said abutment ends slide in contact so as to push said first punches and/or second punches within the respective dies with a predefined compacting force, which is lower than a compression force imparted by said first compression roller and said second compression roller on said first punches and/or second punches, in order to compact said dosed product and allow air in said product to exit.

2. The tablet press machine according to claim 1, wherein said compacting cam is arranged and configured to move said first punches and/or said second punches for a compacting time equal to 10-25 times a compression time in which said first punches and said second punches are moved in said compression station to compress said product.

3. The tablet press machine according to claim 1, wherein said compacting cam is adjustable along an adjustment direction, which is substantially parallel to a rotation axis of said compression turret, so as to vary a compacting stroke of said first punches and/or said second punches within the dies.

4. The tablet press machine according to claim 1, wherein said sliding surface of said compacting cam has a substantially rectilinear profile.

5. The tablet press machine according to claim 1, wherein said compacting station comprises a load meter associated with said compacting cam and configured to measure a compacting force applied by said first punches and/or by said second punches on the product contained within the respective dies.

6. The tablet press machine according to claim 5, wherein said compacting cam is adjustable along an adjustment direction, which is substantially parallel to a rotation axis of said compression turret, so as to vary a compacting stroke of said first punches and/or said second punches within the dies and wherein said tablet press machine comprises a control unit connected to said load cell and configured to receive data related to the compacting force measured by said load cell and to stop the operation of the tablet press machine in case of anomalies and/or to adjust the position of the compacting cam along said adjustment direction to modify the compacting force.

7. The tablet press machine according to claim 1, wherein said at least one compacting cam comprises a first and a second compacting cam configured to drive said first and said second punches, respectively.

8. The tablet press machine according to claim 1, comprising a pre-compression station interposed between said compression station and said compacting station and provided with a first pre-compression roller and a second pre-compression roller adapted to linearly move respectively said first punches and said second punches within the dies in order to pre-compress said product.

9. A method for producing tablets in a rotary tablet press machine that comprises a rotating compression turret, which includes a die table provided along a circumferential portion thereof with a plurality of dies, a plurality of first punches and a corresponding plurality of second punches associated in pairs with respective dies, said first punches and said second punches having a substantially cylindrical body provided with an abutment end on which respectively a first compression roller and a second compression roller act in contact, the method comprising the steps of:
dosing in said dies a product;
compressing said product dosed in said dies by moving said first punches and said second punches, imparting an settled thrust on said abutment ends of respective first punches and second punches by means of contact with said first compression roller and said second compression roller, to compress said product within the respective dies so as to produce tablets;
wherein it comprises, after said step of dosing and before said step of compressing, a step of compacting said product dosed in said dies by applying to said abutment ends of said first punches and/or said second punches a predefined compacting force carried out by sliding said abutment ends in contact with at least one compacting cam so as to push said first punches and/or said second punches within the respective dies and allow air in said product to exit.

10. The method according to claim 9, wherein said step of compacting is performed in a compacting time equal to 10-25 times a compression time in which said step of compressing is performed.

11. The method according to claim 9, comprising during said step of compacting, a step of measuring a compacting force applied by said first punches and/or said second punches on said product within said dies.

12. The method according to claim 9, further comprising a step of adjusting said compacting force applied by said first punches and/or said second punches on said product within said dies by adjusting the position of said at least one compacting cam.

13. The method according to claim 9, comprising, after said step of compacting and before said step of compressing, a step of pre-compressing said product in said dies by moving said first punches and said second punches within said dies.
